(19) United States
(12) Patent Application Publication
(10) Pub. No.: US 2016/0266794 A1
(43) Pub. Date: Sep. 15, 2016

(54) SEMICONDUCTOR DEVICE AND MEMORY SYSTEM

(71) Applicant: KABUSHIKI KAISHA TOSHIBA, Tokyo (JP)

(72) Inventor: Miki ISHIBASHI, Yokohama Kanagawa (JP)

(21) Appl. No.: 14/838,832

(22) Filed: Aug. 28, 2015

(30) Foreign Application Priority Data
Mar. 9, 2015 (JP) 2015-046516

(51) Int. Cl. G06F 3/06

(52) U.S. Cl. CPC G06F 3/061; G06F 3/0679; G06F 3/0659

(57) ABSTRACT

A memory device includes an interface to a host device, a semiconductor memory element, and a controller configured to perform a write operation on the semiconductor memory element in response to a command received from the host device, and upon completion of the write operation, either output a completion notification to the host device or suspend outputting the completion notification based on a load on the controller.

### CROSS-REFERENCE TO RELATED APPLICATION

This application is based upon and claims the benefit of priority from Japanese Patent Application No. 2015-046516, filed on Mar. 9, 2015, the entire contents of which are incorporated herein by reference.

### FIELD

Embodiments described herein relate generally to a semiconductor device and a memory system.

### BACKGROUND

A semiconductor device on which a NAND type flash memory or a controller is mounted on a substrate is provided as a storage medium.

### DESCRIPTION OF THE DRAWINGS

FIG. 1 is a system configuration diagram of a memory system according to a first exemplary embodiment.

FIG. 2 is an external view of the memory system of FIG. 1 according to the first exemplary embodiment.

FIGS. 3A and 3B are external views of a semiconductor device according to the first exemplary embodiment.

FIG. 4 is an internal configuration view of the semiconductor device of FIGS. 3A and 3B according to the first exemplary embodiment.

FIG. 5 is a logical configuration diagram of a controller mounted on the semiconductor device of FIGS. 3A and 3B according to the first exemplary embodiment.

FIG. 6 is a flowchart showing an example of command processing of the semiconductor device of FIGS. 3A and 3B according to the first exemplary embodiment.

FIG. 7 is a view illustrating an example of a method of notifying write completion of the memory system according to the first exemplary embodiment.

FIG. 8 is a view illustrating another example of the method of notifying write completion of the memory system according to the first exemplary embodiment.

FIG. 9 is a flowchart showing another example of command processing of the semiconductor device according to the first exemplary embodiment.

FIG. 10 is a logical configuration diagram of a controller mounted on a semiconductor device according to a second exemplary embodiment.

FIG. 11 is a flowchart showing an example of command processing of the semiconductor device of FIG. 10 according to the second exemplary embodiment.

FIG. 12 is a diagram illustrating an example of a relationship between the time required for writing and the temperature of the controller.

FIG. 13 is a logical configuration diagram of a controller mounted on a semiconductor device according to a third exemplary embodiment.

FIG. 14 is a flowchart showing an example of command processing of the semiconductor device of FIG. 13 according to the third exemplary embodiment.

### DETAILED DESCRIPTION

In general, according to an exemplary embodiment, a memory device includes an interface to a host device, a semiconductor memory element, and a controller configured to perform a write operation on the semiconductor memory element in response to a command received from the host device, and upon completion of the write operation, either output a completion notification to the host device or suspend outputting the completion notification based on a load on the controller.

Hereinafter, exemplary embodiments will be described with reference to the accompanying drawings.

In the present specification, several embodiments may be expressed in multiple additional ways. Further, the embodiments described herein are merely examples, and the embodiments are not limited to those examples.

In addition, the accompanying drawings are schematic and the relationship between the thickness and the plane dimension or the ratio of the thicknesses of respective layers may not be to scale. Further, drawings may include parts whose relationships or ratios among dimensions are different from one another.

### First Exemplary Embodiment

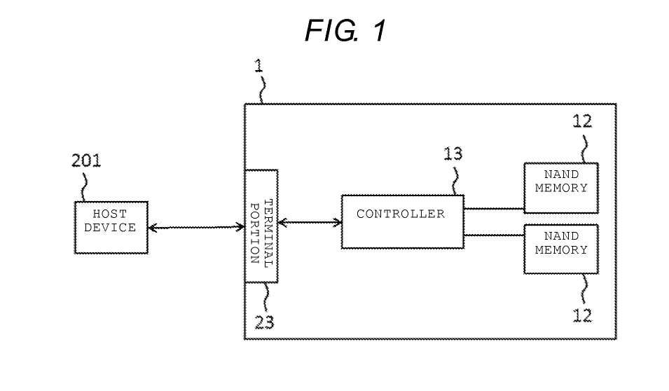

FIG. 1 is a system configuration diagram illustrating a memory system according to a first embodiment. The memory system according to the present exemplary embodiment is configured with a host device 201 and a semiconductor device 1. In addition, the semiconductor device 1 is an example of a “semiconductor module” or a “semiconductor memory device.” The semiconductor device 1 according to the present exemplary embodiment is, for example, a microSD card, but is not limited thereto. In the first exemplary embodiment, the semiconductor device 1 includes a measuring component that directly measures a thermal response (e.g., a temperature) of a controller 13 in semiconductor device 1 and/or a portion of semiconductor device 1.

The semiconductor device 1 as illustrated in FIG. 1 includes one or more NAND type flash memories (hereinafter, abbreviated as a “NAND memory”) 12 as a nonvolatile semiconductor memory element, a controller 13, and a terminal portion 23. The terminal portion 23 is an interface such as a serial bus interface (SBI), connected to a portable computer, which is an example of an electronic device, and to the host device 201, such as a CPU core using UHS-I, UHS-II, or the like as a physical layer standard, so that the semiconductor device 1 functions as an external memory of the host device 201. Further, the interface may be in conformity with another standard. Moreover, if the example of the present exemplary embodiment is applied to an SSD or the like, the interface may be connected to the host device 201 through a memory connection interface such as an interface according to a standard such as serial advanced technology attachment (SATA) or peripheral component interconnect express (PCIe).

The semiconductor device 1 receives power supplied from the host device 201 through an interface. Examples of the host device 201 include electronic devices such as a video camera, a game machine, a notebook type portable computer, a tablet terminal, and a detachable notebook personal computer (PC). In the present exemplary embodiment, a notebook type portable computer may be used as the host device 201, but the host device 201 is not limited thereto.

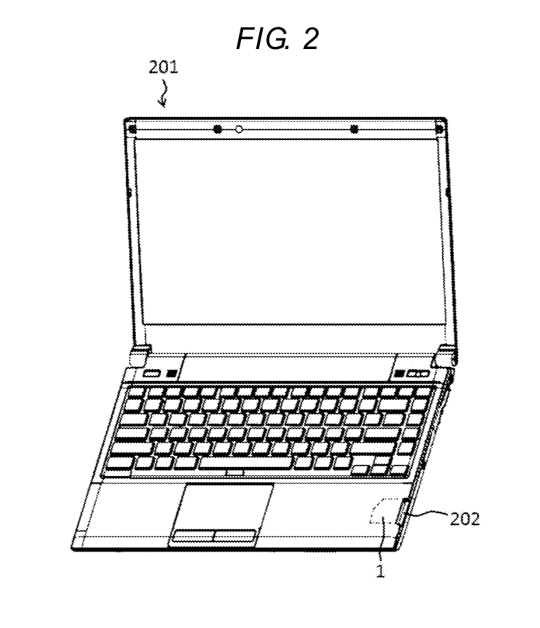

FIG. 2 is a view illustrating a notebook type portable computer to which the semiconductor device 1 is coupled. As illustrated in FIG. 2, the semiconductor device 1 is employed while inserted into an insertion portion 202 of the notebook type portable computer. In addition, an embodiment in which the semiconductor device 1 is inserted into a keyboard side of the notebook type portable computer is illustrated in FIG. 2. If the semiconductor device 1 is used for a detachable PC, the insertion portion 202 for the semiconductor device 1 may be provided on a display side, and thus the semiconductor device 1 may be used as an external memory even if only the display side is used as a tablet terminal.

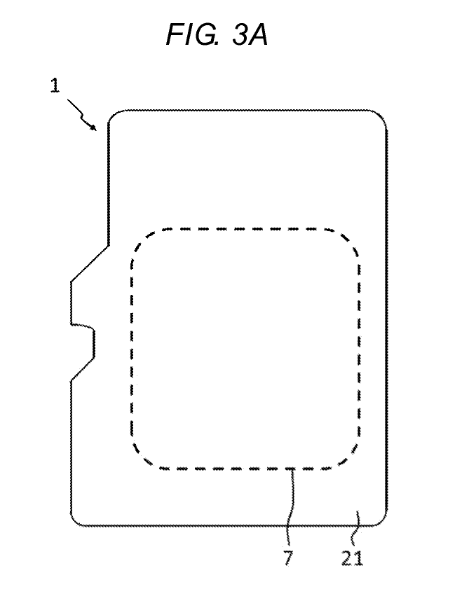

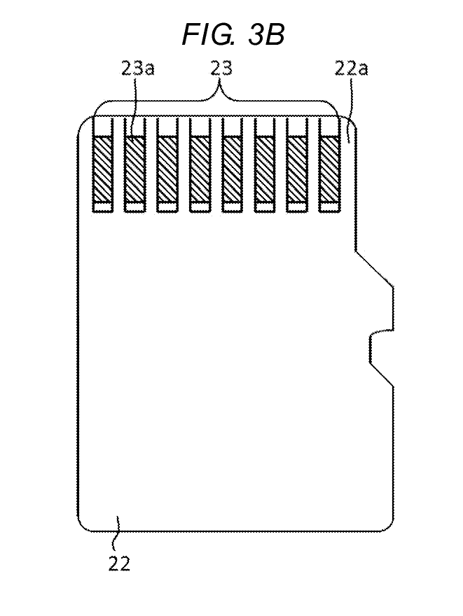

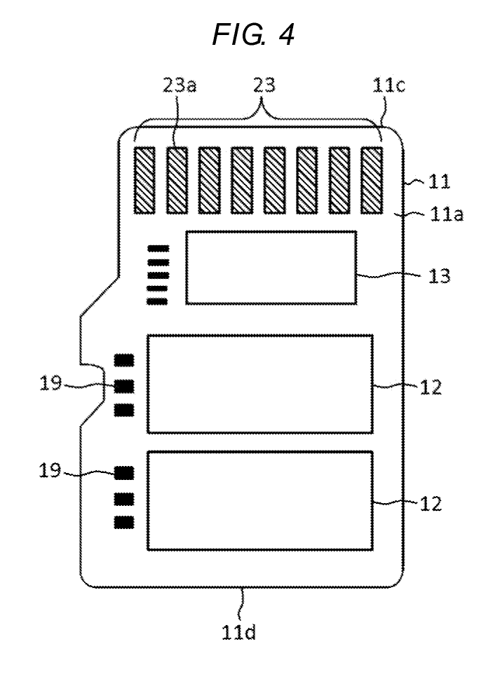

FIGS. 3A and 3B are views illustrating specific examples of the external structure of the semiconductor device 1. In FIGS. 3A and 3B, FIG. 3A is a plan view and FIG. 3B is a view seen from the opposite side of FIG. 3A. Further, FIG. 4 illustrates a specific example of the internal structure of the semiconductor device 1. As shown in FIG. 4, the semiconductor device 1 includes a substrate 11, at least one NAND memory 12 mounted on the substrate 11, a controller 13, and other electronic components 19, such as resistors and/or capacitors. In the semiconductor device 1, the substrate 11 on which components such as the above-described NAND memory 12 are mounted is sealed by a first sealing portion 21 (shown in FIG. 3A) and a second sealing portion 22 (shown in FIG. 3B).

Returning to FIG. 4, the substrate 11 is a printed substrate configured of materials such as a glass epoxy resin and has a substantially rectangular shape in a plan view. Further, the substrate 11 has a multilayer structure formed by stacking a synthetic resin and wiring patterns (not illustrated) that are formed in various shapes on the surface or the inner layer of each layer. The components such as the NAND memory 12 and the controller 13 are electrically connected to each other through the wiring patterns formed on the substrate 11.

Moreover, the substrate 11 includes a first surface 11a and a second surface 11b positioned on the opposite side of the first surface 11a. The terminal portion 23, including a plurality of connection terminals 23a, is disposed on the second surface 11b. Further, the substrate 11 includes a first edge portion 11c along the lateral direction and a second edge portion 11d positioned on the opposite side of the first edge portion 11c, and the connection terminals 23a are arranged along the first edge portion 11c.

For example, CLK (clock), Vdd (power supply), Vss (grand), CMD (command), and the like are assigned to the plurality of connection terminals 23a and are respectively provided for various signals different from one another. Further, in FIGS. 3A to 4, although a case where eight terminals are arranged as the plurality of connection terminals 23a is illustrated, the number of the plurality of connection terminals 23a is not limited thereto and the positional relationship among respective terminals is determined according to any known standard in the art.

In addition, in the present specification, although the first surface 11a of the substrate 11 is described as the component-mounting surface on which the NAND memory 12, the controller 13, and the like are mounted, in some embodiments, the NAND memory 12, the controller 13, and the like are not necessarily mounted only on the first surface 11a of the substrate 11. For example, the NAND memory 12, the controller 13, and the like may be mounted on the second surface 11b depending on the number or the size of the NAND memory and/or the requirements of suitable wiring paths.

The NAND memory 12 is a nonvolatile semiconductor memory element, and includes, for example, memory cells having a stacked gate structure or memory cells having a metal-oxide-nitride-oxide-silicon (MONOS) structure.

The controller 13 controls the operation of the NAND memory 12. Specifically, the controller 13 controls writing of data on the NAND memory 12, reading of data from the NAND memory 12, and data erasure from the NAND memory, 12 and manages a state of data being stored in the NAND memory 12.

Moreover, in the present exemplary embodiment, although the NAND memory 12 and the controller 13 are respectively mounted on the substrate 11 as individual packages, the NAND memory 12 and the controller 13 may be mounted on the substrate 11 as one package.

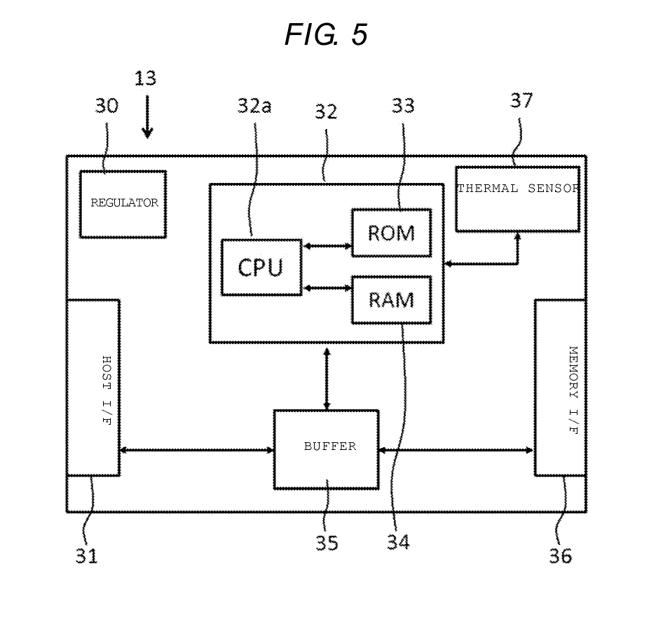

The controller 13 includes a host interface (I/F) 31, a CPU 32, a Read Only Memory (ROM) 33, a Random Access Memory (RAM) 34, a buffer 35, and a memory interface (I/F) 36 (all described below in conjunction with FIG. 5). These are connected to each other through a bus. The NAND memory 12 is connected to the memory interface 36.

The first sealing portion 21 includes all components mounted on the first surface 11a of the substrate 11, and covers the first surface 11a side of the substrate 11. Although the first sealing portion 21 (shown in FIG. 3A) is described as being formed from a sealing resin, such as an epoxy resin, the first sealing portion 21 is not limited thereto. Further, a design layer 7 that displays optional information desired by a manufacturer is formed in the first sealing portion 21, and images or character strings are printed in some cases. Moreover, the design layer 7 is not limited to printing and may be attached to the first sealing portion 21 as a seal. Further, the manufacturer may perform stamping for identification on the design layer 7 using an optional method (for example, a laser).

In addition, if stamping for identification is performed on the design layer 7 using a laser, it is preferable that the NAND memory 12 or the controller 13 are not arranged on the first sealing portion side in order to reduce the risk of adversely affecting the performance of the NAND memory 12 or the controller 13.

Moreover, in a case of the microSD card, a logo mark or the like needs to be displayed, since non-display of the logo mark is not permitted. For this reason, information such as a logo mark or the like may be displayed on the design layer 7.

The second sealing portion 22 (shown in FIG. 3B) exposes the connection terminal 23a provided on the second surface 11b of the substrate 11, and seals the second surface 11b side of the substrate 11 together with a mounting component (for example, the NAND memory 12). Moreover, although the second sealing portion 22 is described as being made of a sealing resin similar to the first sealing portion 21, second sealing portion 22 is not limited thereto.

Further, as illustrated in FIG. 3B, the second sealing portion 22 includes a plurality of projections 22a configured so as to avoid the terminal portion 23. In addition, a slit (not illustrated) is formed in the insertion portion 202 of the host device 201, and the projection 22a is fitted to the slit. In this manner, the semiconductor device 1 is physically and electrically stabilized when inserted into the host device 201.

Further, for the sake of convenience of description, the first sealing portion 21 and the second sealing portion 22 are separately described, but the first sealing portion 21 and the second sealing portion 22 are not necessarily independent from each other. The substrate 11 may be sealed using a method of circulating a resin to the first surface 11a side and to the second surface 11b side of the substrate 11 simultaneously. Cooling the resin may be performed so that the entire substrate 11 is covered from the first surface 11a side and the second surface 11b side. Alternatively, the substrate 11 may be covered by preparing the first sealing portion 21 and the second sealing portion 22 separately and fitting the first sealing portion 21 and the second sealing portion 22 to each other.

FIG. 5 is a diagram illustrating an example of a logical configuration of the controller 13. A regulator 30 generates a predetermined voltage necessary for the NAND memory 12 or the like from the power supplied from the host device 201. In addition, the regulator 30 is preferably arranged so as to be close to the terminal portion 23 side in the inside of the controller 13 in order to suppress loss of power supplied from the host device 201.

In the present exemplary embodiment, although the regulator 30 is included in the controller 13 as described above, a power supply circuit having the same function as the regulator 30 may be mounted on the substrate 11 if the regulator 30 is not included in the controller 13.

The host interface 31 performs interface processing between the controller 13 and the host device 201. The memory interface 36 performs interface processing between the controller 13 and the NAND memory 12. Data may be transferred between the host interface 31, the RAM 34, and the buffer 35 through direct memory access (DMA) transfer using hardware in addition to data transfer using the CPU 32.

The CPU block 32 includes the CPU 32a, the ROM 33, and the RAM 34. The CPU 32a controls the overall operation of the semiconductor device 1. The CPU 32 executes a predetermined process by loading firmware (e.g., a control program or the like) stored in the ROM 33 or firmware recorded in the NAND memory 12 on the RAM 34. That is, the CPU 32 creates various tables or an expanded register (described below on the RAM 34), accesses an area on the NAND memory 12 by receiving a write command, a read command, or an erase command from the host device 201, and controls data transfer processing through the buffer 35.

The ROM 33 stores firmware such as a control program or the like to be used by the CPU 32. The RAM 34 is used as a working area of the CPU 32, and stores the control program, various tables, the expanded register described below, and the like.

The buffer 35 temporarily stores a certain amount of data (for example, an amount corresponding to one or more pages of data) when data sent from the host device 201 is written on the NAND memory 12. Alternatively or additionally, the buffer 35 temporarily stores a certain amount of data when data read from the NAND memory 12 is sent to the host device 201. An SD bus interface and a back end are synchronously controlled through the buffer 35. In addition, the buffer 35 may include a host buffer (not illustrated) that temporarily stores data received from the host device 201 and a NAND buffer (not illustrated) that temporarily stores data read from the NAND memory 12.

A thermal sensor 37 measures the temperature of the controller 13. The temperature of the thermal sensor 37 may be constantly measured while the semiconductor device 1 is inserted into the host device 201, or may be measured at a predetermined cycle, for example, once every 10 seconds. Further, the temperature may be measured only when a command is received from the controller 13 or the host device 201 through the controller 13.

In addition, “the temperature of the controller 13” herein is a temperature measured at a position on which the thermal sensor 37 is mounted. In some embodiments, the temperature of the ambient outside air of the controller 13 is included as well as the temperature of the controller 13, such as when the thermal sensor 37 is arranged on or near an external portion of the controller 13. Further, when the controller 13 is connected to the first sealing portion 21 or the second sealing portion 22, the temperature of the area of the first sealing portion 21 or the second sealing portion 22 that is affected by heat of the controller 13 is also included as a contributor to the above-described “temperature of the controller 13.” In addition, the host interface 31 may be disposed proximate the terminal portion 23 of the substrate 11, that is, close to the first edge portion 11c in the inside of the controller 13. In this case, wiring connecting the host interface 31 and the terminal portion 23 of the substrate 11 may be shortened.

For example, if the host interface 31 is disposed opposite the terminal portion 23, that is, close to the side of controller 13 that is closest to the second edge portion 11d, the wiring distance is extended by the length of the controller 13 in the lateral direction as understood from FIG. 4. Extended wiring length increases parasitic capacitance, parasitic resistance, and parasitic inductance, and characteristic impedance of a signal wiring becomes difficult to maintain. Further, when the wiring becomes longer, this may lead to signal delay.

In addition, it is preferable that an electronic component is not mounted on a space between the host interface 31 and the terminal portion 23 of the substrate 11.

As described above, if the wiring distance between the host interface 31 and the terminal portion 23 is extended, problems are generated in that the impedance of the signal wiring becomes difficult to maintain and signal delay occurs. Therefore, in order to implement wiring that connects the host interface 31 with the terminal 23 with a minimal or reduced length, it is preferable that an electronic component is not mounted in the space between the host interface 31 and the terminal portion 23.

For the reason described above, the controller 13 is arranged in the vicinity of the terminal portion 23 and the host interface 31 of the controller 13 is arranged close to the direction of the terminal portion 23 of the substrate 11 in the inside of the controller 13. Further, it is preferable that none of the electronic components 19 or the like are disposed in the space between the controller 13 and the terminal portion 23.

In addition, in the present exemplary embodiment, the memory interface 36 is disposed on the opposite side of the controller 13 that is proximate the terminal portion 23 of the substrate 11, that is, close to the second edge portion 11d in the inside of the controller 13. In this case, operation stability of the semiconductor device 1 may be improved by shortening the wiring distance between the memory interface 36 and the NAND memory 12.

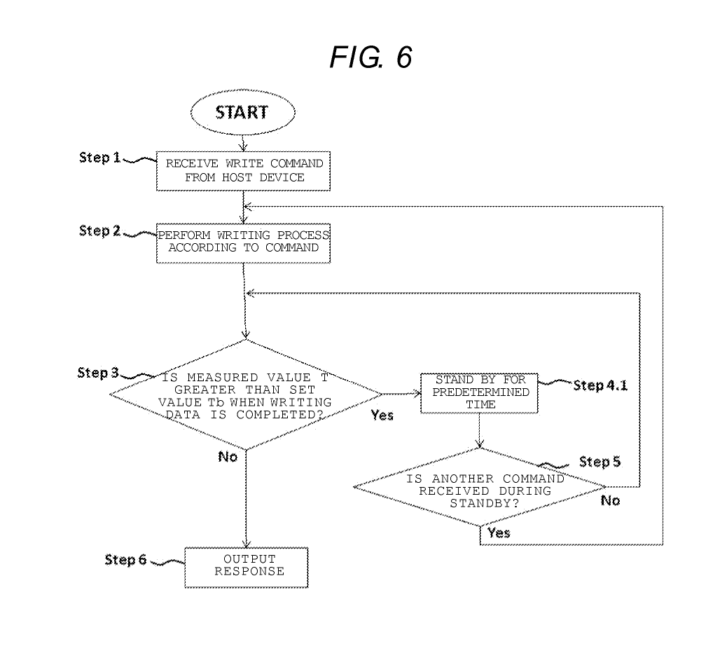

FIG. 6 is a flowchart showing an example of command processing of the controller 13 in the present exemplary embodiment. The controller 13 receives commands such as a write command, a read command, and an erase command from the host device 201. A case where the write command is received from the host device 201 is described herein (Step 1).

Moreover, at Step 1, the host device 201 sends address information or the like to the semiconductor device 1, indicating the amount of data associated with the writing process and the address information associated with the data (e.g., logical block addresses). The semiconductor device 1 in which the address information or the like is received accesses to the NAND memory 12 and determines whether receipt of data is possible. If receipt of data, that is, writing of a command is possible, a response indicating that the writing is possible is returned to the host device 201, and write data is received from the host device 201. This procedure is omitted in the flowchart of FIG. 6, and the description is made with the assumption that writing on the NAND memory 12 is possible.

The controller 13 receives data for writing (hereinafter “write data”), and performs a writing process on the NAND memory 12 according to the command received from the host device 201 (Step 2). Further, the write data received from the host device 201 is temporarily stored in the buffer 35. A portion of write data received at this time is, for example, a page unit of write data.

When the writing of write data associated with the write command received from the host device 201 is completed, the temperature of the controller 13 measured by the thermal sensor 37 is determined, and it is confirmed whether a temperature T of the controller 13 is higher than a threshold value, such as a predetermined maximum removal temperature Tb (for example, Tb is 70° C.) (Step 3).

If the temperature T of the controller 13 at the time of completion of writing is higher than the predetermined maximum removal temperature Tb, the controller 13 stands by until the temperature T of the controller 13 sensed by the thermal sensor 37 is decreased to the predetermined maximum removal temperature Tb (Step 4.1) without outputting a write completion response to the host device 201. Then, it is confirmed whether the temperature T of the controller 13 is higher than the predetermined maximum removal temperature Tb again (Step 3) and the write completion response is output to the host device 201 when the value of the temperature T is lower than the value of the predetermined maximum removal temperature Tb (Step 6).

Further, the write completion response here indicates to the host device 201 the completion of writing the write data associated with the write command. The controller 13 outputs the response to the host device 201 after the data are written, and the host device 201, after the output response is received, notifies a user on a display 203 of the progress of completion of the total pending write commands, for example: “30% of the data writing completion”. At this time, the progress state of these write commands may be set so as to be easily determined visually by showing characters, a meter, and the like.

In the present exemplary embodiment, even when the controller 13 completes a writing process, a notification (display using characters, for example, “100% of data writing completion”) of writing completion is not displayed on a display until a relationship of “T≦Tb” is satisfied. Thus, if T>Tb is currently the case, the notification that the most recently completed write command is actually completed is not sent to the host. The notification which allows the user to recognize completion of the write data being written is referred to as a writing completion notification in the present exemplary embodiment.

In this manner, even when the semiconductor device 1 is intended to be removed immediately after the user confirms the writing completion notification, it is possible to prevent the user from getting a burn since the user takes the semiconductor device 1 out in a state in which the surface temperature thereof is decreased.

In addition, when the user takes out the semiconductor device 1 in a state in which the surface temperature thereof is high, there is a possibility that the user accidentally drops the semiconductor device 1. However, the risk of the semiconductor device 1 accidentally being dropped by the user may be reduced because the semiconductor device 1 is taken out by the user in a state in which the surface temperature thereof is decreased.

With the miniaturization of memory cards in recent years, a heat dissipation mechanism becomes difficult to provide for the memory card itself. Further, there is a possibility that heat generated from the controller is not sufficiently dissipated when the memory card becomes smaller, and because the controller may have multiple additional functions, the heat transfer rate tends to increase. In this case, there is a concern that the operating temperature inside of the semiconductor device 1, the first sealing portion 21, and the second sealing portion 22 is further increased by additional heat generation by the controller 13. Accordingly, the user who receives confirmation that a writing process is completed may receive a burn while removing the semiconductor device 1.

In the present exemplary embodiment, when it is confirmed that the temperature T of the controller 13 (is measured by the thermal sensor 37) is higher than the predetermined maximum removal temperature Tb (for example, Tb is 70° C.) at the time of removal of the semiconductor device 1, the controller 13 stands by for a predetermined time, and then transmits a notification that the semiconductor device 1 may be removed (e.g., electrically disconnected) from the host device 201. For example, when the temperature T is higher than the predetermined maximum removal temperature Tb when a request for removing the semiconductor device 1 is received in the middle of data writing, the writing completion response is not output to the host device 201 until after standing by for a predetermined time. Thus, the writing completion response is not output immediately after the completion of writing.

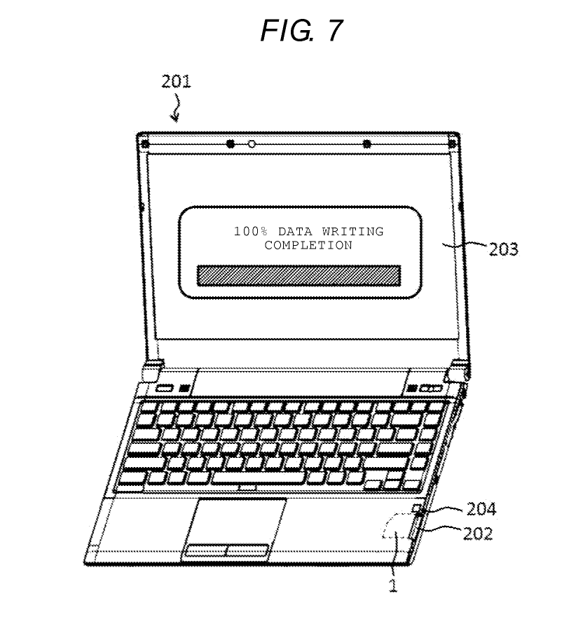

In some embodiments, the user confirms the writing completion notification, and removes the semiconductor device 1 as described above. The notification portion that notifies the user of the writing completion at this time is, for example, the display 203 of the host device 201, as described above. When the host device 201 is a device having a display such as a notebook type portable computer, a tablet terminal, or a detachable notebook PC, or when the response indicating the writing completion is received by the host device from the semiconductor device 1, characters may be displayed, for example, “100% of the data writing completion” or “removal permitted” on the display 203 as the writing completion notification, as illustrated in FIG. 7.

In some embodiments, the writing completion notification is not necessarily performed using characters. For example, a technique of lighting a part of the screen displayed on a display or changing the color thereof may be used. Alternatively, when an icon indicating electrical connection between the host device 201 and the semiconductor device 1 is already displayed, the writing completion may be provided to the user as a writing completion notification in which such an icon is no longer displayed. For example, the time at which the icon is not displayed is not the time at which the writing is completed, but instead is the time at which the relationship of “T≦Tb” is satisfied.

Further, a light emitting portion 204 included in the host device 201 (shown in FIG. 7), such as an LED or the like, may be used as such a notification portion. When the host device receives the writing completion response from the semiconductor device 1, the user may be notified of writing completion by lighting or flickering the light emitting portion 204 of the host device 201. In addition, a notification may be displayed on the display 203 at this time as described above.

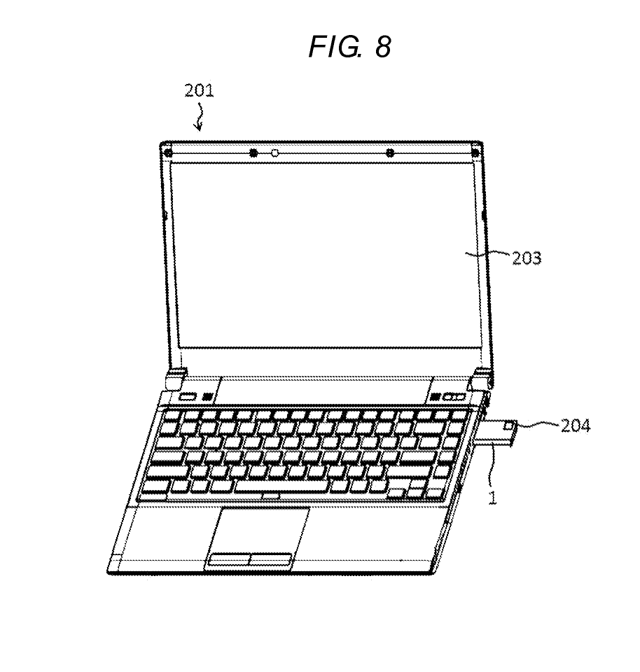

Further, when the semiconductor device 1 is connected to the host device 201, the above-described light emitting portion 204 may be provided in the semiconductor device 1 as illustrated in FIG. 8, if a part of the semiconductor device 1 is exposed from the host device 201 and visible to the user (for example, a USB memory). In this case, the writing completion response is not necessarily sent to the host device, and the user may determine whether the semiconductor device 1 may be taken out from the lighting state of the light emitting portion 204 included in the semiconductor device 1.

Further, for example, when the host device 201 receives the writing completion response from the semiconductor device 1, the host device 201 may have a configuration in which an alarm sound indicating that the semiconductor device may be taken out is sounded or may have a configuration in which a lock is not released until the host device 201 receives the writing completion response from the semiconductor device 1 by providing a mechanism (not illustrated) of a lock or the like in the insertion portion 202 of the host device 201.

Moreover, in the semiconductor device 1, it is possible to prevent the user from getting a burn when removing the semiconductor device 1 by generally dropping the transfer rate of data so as to suppress generation of heat of the controller. However, this method is not preferable because the processing capacity of the semiconductor device 1 is degraded.

In the present exemplary embodiment, it is possible to prevent the user from getting a burn without degrading the processing capacity of the semiconductor device 1.

In addition, a maximum operating temperature Tp is stored in the controller 13 used for the semiconductor device 1. The maximum operating temperature Tp is normally higher than the predetermined maximum removal temperature Tb at which the user may get a burn. For example, in one embodiment, for example, the maximum operating temperature Tp is 90° C. (Tb<Tp). If the temperature T of the controller 13 is higher than the maximum operating temperature Tp, an increase in the temperature of the controller 13 may be prevented by dropping the data transfer rate as described above.

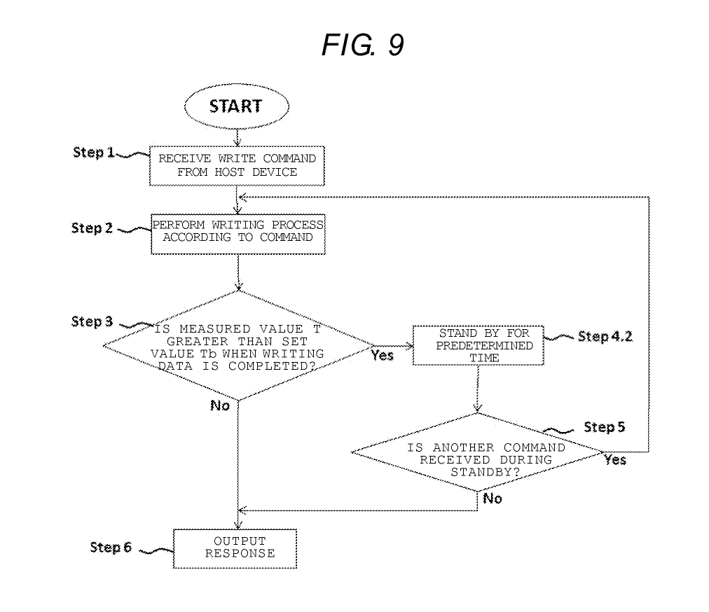

In addition, the thermal sensor 37 does not necessarily perform measurement continuously until the temperature T of the controller 13 is cooled to the predetermined maximum removal temperature Tb. Instead, the writing completion response may be output to the host device 201 after standing by for a predetermined time (for example, 5 seconds) (Step 4.2) when the temperature T of the controller 13 at the time of the writing completion is higher than the predetermined maximum removal temperature Tb as shown in the flowchart of FIG. 9. Moreover, the thermal sensor 37 of the present exemplary embodiment is not necessarily provided in the controller 13, and may be disposed on the substrate 11 separate from the controller 13.

### Second Exemplary Embodiment

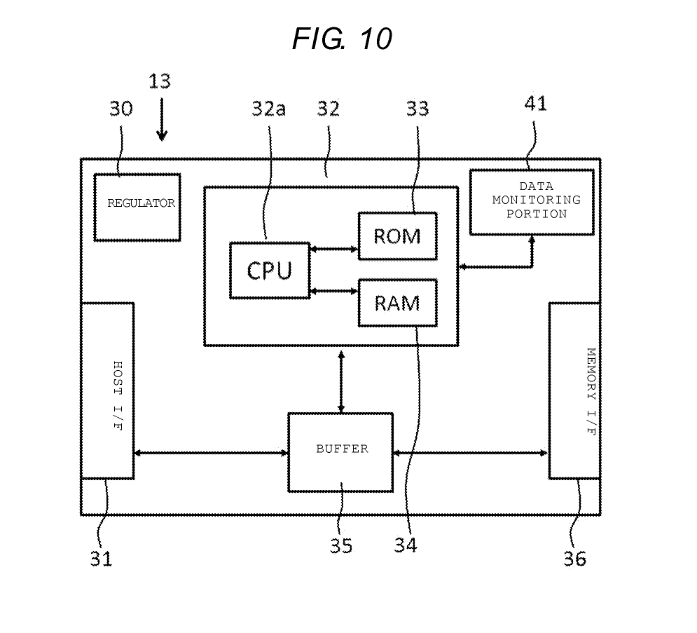

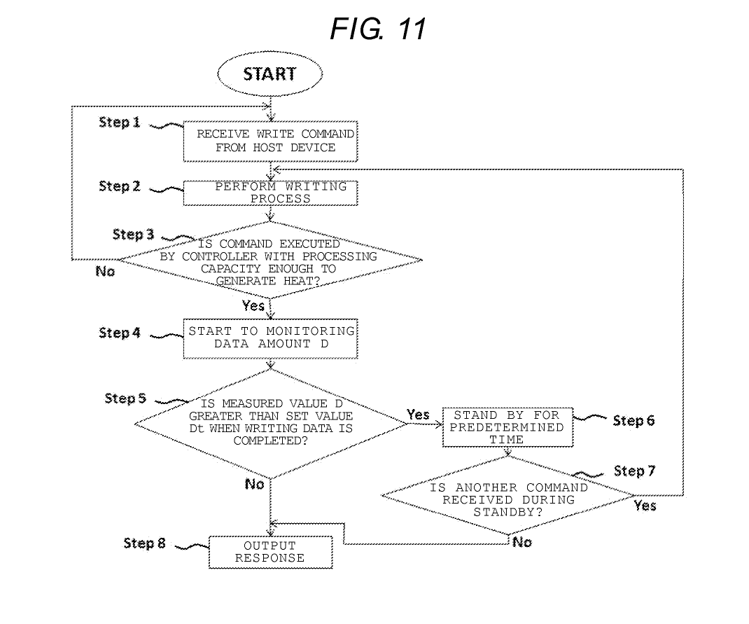

FIG. 10 illustrates a logical configuration of the controller 13 used in the present exemplary embodiment. In addition, FIG. 11 is a flowchart showing an example of the command processing of the present exemplary embodiment. In the description of the present exemplary embodiment, the configurations which are the same as those of the first exemplary embodiment are denoted by the same reference numerals and specific descriptions thereof are not repeated. In the present exemplary embodiment, the thermal sensor 37 is not necessarily provided in the controller 13 and the controller 13 includes a data monitoring portion 41 that monitors a quantity of data that is processed by the controller 13.

The data monitoring portion 41 monitors a data quantity D that is a total amount of write data d[1], d[2], . . . , d[n] processed when all write data received from the host device 201 are written in the NAND memory 12.

The controller 13 receives a command from the host device 201 (Step 1). In the present exemplary embodiment, a case where the controller 13 receives a write command from the host device 201 is described, but in other embodiments, other commands may be received from the host device 201. The controller 13 performs the writing process according to the command received from the host device 201 (Step 2).

Then, the controller 13 confirms whether the controller performs the writing process with sufficiently high processing capacity to continuously increase the temperature (Step 3). For example, the temperature of the controller 13 increases to a relatively high value (for example, 70° C. or higher) when a predetermined amount of data are written over a specific time period, a predetermined time passes during which data are written at a particular rate, or work is performed (e.g., computational activities in addition to data writing) in which a predetermined thermal response is completed while the controller 13 is continuously operated at a high processing capacity. The state of performing a process with “high processing capacity,” in the present exemplary embodiment, indicates a state of operation in which the temperature of the controller 13 continuously increases despite natural heat dissipation also occurring.

When it is determined that the controller 13 does not perform the writing process with high processing capacity, as described above, the process is returned to Step 1 and the writing process is performed. That is, when the controller 13 is not operated with the processing capacity to the extent that the temperature thereof is increases significantly during the writing of data, the process is returned to Step 1.

By contrast, when the controller 13 performs the writing process with high processing capacity, the data monitoring portion 41 starts to measure the data quantity D of the write data that are received from the host device 201 (Step 4).

Subsequently, when writing of write data associated with the command received from the host device 201 is all completed, it is confirmed whether the total quantity D of data written by the controller 13 measured by the data monitoring portion 41 exceeds a predetermined data quantity Dt (Step 5).

At this time, when the total quantity D is smaller than the predetermined data quantity Dt (where Dt is set in advance), the writing completion response is output to the host device 201. Meanwhile, when the total quantity of data D is larger than the predetermined data quantity Dt, it is assumed that the temperature of the controller 13 reaches a high temperature. Consequently, after the writing of data is completed (Step 7), a predetermined time period (for example, 30 seconds) transpires before the writing completion response is output to the host device 201. Thus, the controller stands by for the predetermined time period before outputting the writing completion response.

In general, the temperature of the controller 13 of the semiconductor device 1 increases as the total amount of write data to be processed increases (i.e., write data to be written in the NAND memory 12 in the case of the present exemplary embodiment). This temperature is input to the semiconductor device 1. However, if the controller 13 performs the writing process at a reduced rate (i.e., with low processing capacity) when the quantity of write data is large (e.g., greater than a predetermined maximum threshold value, such as predetermined data amount Dt), the temperature of the controller 13 may not increase significantly. In the present exemplary embodiment, a predetermined data quantity Dt is set as a threshold value and a time interval that allows the surface temperature of the semiconductor device 1 to decrease is implemented by standing by for a predetermined time interval before the writing completion response is output to the host device 201 when the input data quantity D is larger than the predetermined quantity of data Dt. Accordingly, even when the user takes out the semiconductor device 1 immediately after the user receives the writing completion notification, the user is prevented from getting a burn when the user removes the semiconductor device 1, since the semiconductor device 1 is in a state in which the surface temperature thereof is decreased.

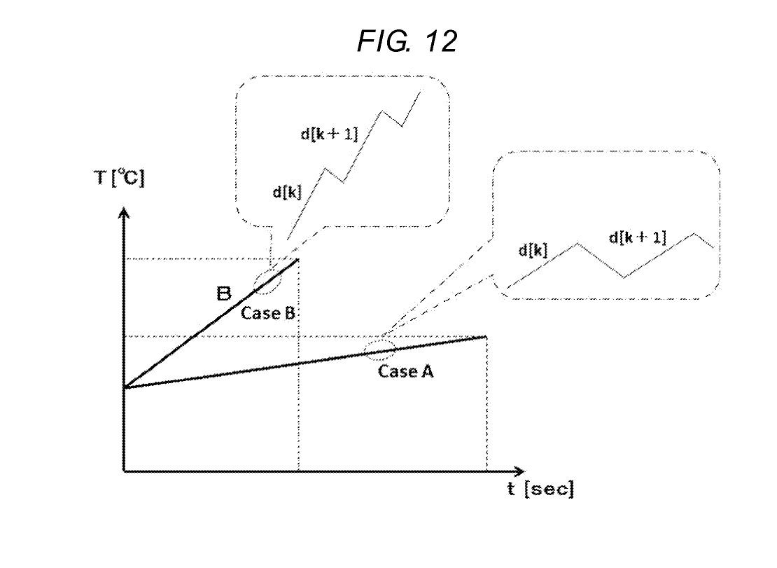

FIG. 12 illustrates an example of a relationship between the time necessary for writing the specific quantity of data D and the temperature of the controller 13 in two cases A and B. In case A, the controller 13 performs data processing with a processing capacity lower than that of case B.

As illustrated in FIG. 12, in case A (in which the controller 13 performs data processing with low processing capacity), the time taken for processing one portion of data d[k] is longer than in case B, and the time required to complete writing all data portions is longer in case A than in case B. Thus, a rate of increase of the temperature of the controller 13 is smaller in case A than in case B, as shown. When case A and case B in FIG. 12 are viewed more closely, the temperature of the controller 13 repeatedly increases and decreases. In case A, the time interval between completion of processing one portion of data d[k] and initiation of processing the next portion of data d[k+1] is longer than that for case B. Consequently, in case A there is more time for a decrease in the temperature of the controller 13 between the processing of data portion d[k] and data portion d[k+1]. Further, since the time employed for processing data portion d[k] in case A is longer than that of the case B, a thermal load applied to the controller 13 is smaller in case A than in case B, and a temperature increase rate at the time of processing data portion d[ k] is smaller in case A than in case B.

In recent years, the controller of a semiconductor device often performs many advanced processes at a high speed. Thus, while the processing capacity of the controller is thereby improved, a thermal load applied to the controller is increased, and the rate of temperature increase in such controllers is greater than controllers with lower processing capacity.

For this reason, in the present exemplary embodiment, the controller 13 monitors the data quantity D, which is a total amount of received write data d1, d2, . . . , dn. As described above, if (1) the data processing speed (processing capacity) per unit time of the controller 13, (2) the temperature increase rate per unit time during processing of data, (3) the temperature decrease rate per unit time when data are not being processed, and (4) the time for completion of all data processing are all known, the temperature of the controller 13 may be determined from the processed data quantity D even without temperature monitoring functionality (e.g., the thermal sensor 37) described in the first exemplary embodiment.

In some embodiments, the time when data are not being processed in the above-described (3) indicates the time interval between completion of processing one portion of data d[k] and initiation of processing the next portion of data d[k+1]. In such embodiments, the quantity of data measured by the data monitoring portion 41 may be reset to zero data when it is determined that a time interval has transpired since the controller 13 receives the subsequent data that is longer than a time interval determined to allow a temperature associated with the semiconductor device 1 becoming lower than a temperature at which the user gets a burn, (for example, 70° C. or lower).

In addition, when in the present exemplary embodiment the thermal sensor 37 is provided in the controller 13 in the same manner as that of the first exemplary embodiment, the thermal sensor 37 monitors the temperature of the controller 13, and the writing completion response may be output to the host device 201 after the temperature T of the controller 13 at the time of completion of writing data is decreased to a predetermined maximum removal temperature Tb (for example, Tb is 70° C.)

Moreover, in such embodiments, the thermal sensor 37 is not necessarily included in the controller 13. Instead, the thermal sensor 37 may be disposed on the substrate 11 separately from the controller 13. Further, the data monitoring portion 41 may be disposed on the substrate 11 separately from the controller 13.

### Third Exemplary Embodiment

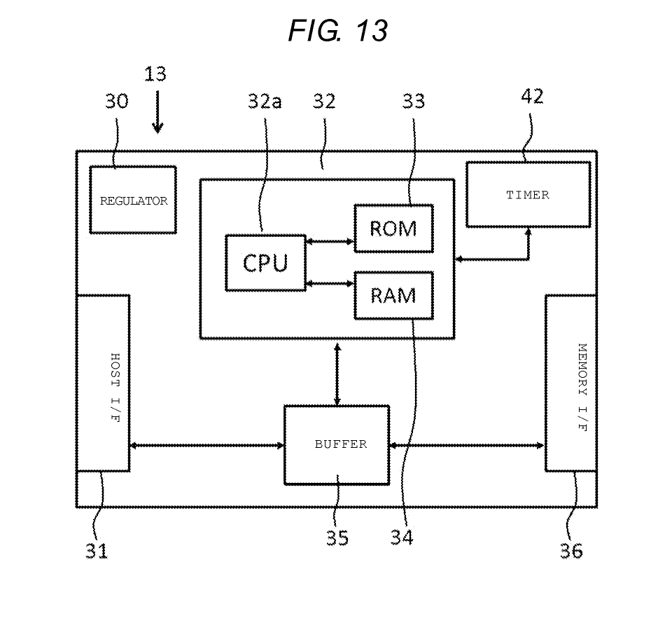

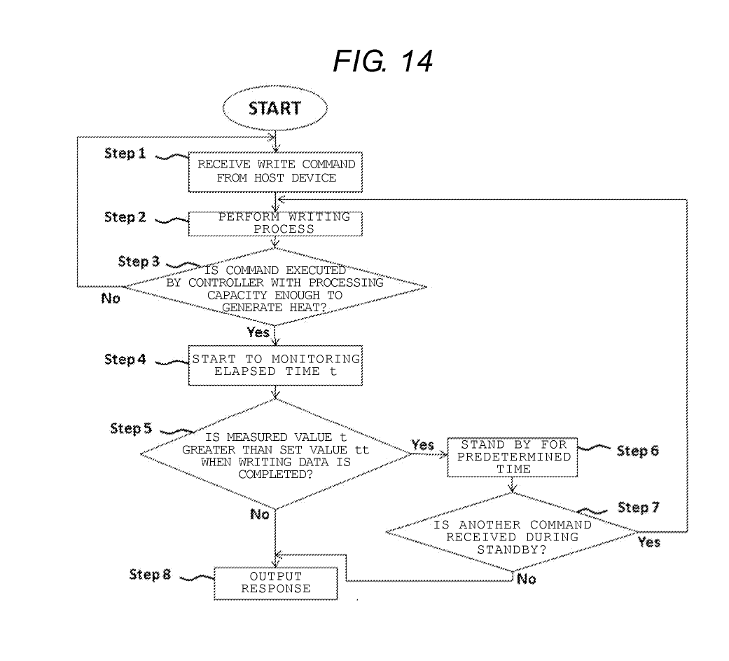

FIG. 13 illustrates a logical configuration of the controller 13 used in the present exemplary embodiment. In addition, FIG. 14 is a flowchart showing an example of command processing of the present exemplary embodiment. In the present exemplary embodiment, the controller 13 includes a timer 42 that monitors the operation time. When the write data received from the host device 201 is written on the NAND memory 12, the timer 42 measures a time t taken from the start to the completion of writing.

The controller 13 receives the command from the host device 201 (Step 1). In the present exemplary embodiment, a case where the controller 13 receives a write command from the host device 201 is described, but in other embodiments, other commands may be received from the host device 201. The controller 13 performs the writing process according to the command received from the host device 201 (Step 2).

Then, the controller 13 confirms whether the writing process is performed with sufficiently high processing capacity to continuously increase the temperature of the controller 13 (Step 3).

The writing process is continued when the controller 13 does not perform the writing process with such high processing capacity.

By contrast, when the controller 13 performs the writing process with high processing capacity, the timer 42 starts to measure the time t taken for writing the write data that are received from the host device 201 on the NAND memory 12 (Step 4).

Subsequently, when the writing of write data associated with the command received from the host device 201 is completed, the time t elapsed for the controller 13 to execute a host command (i.e., process the write data) (which is measured by the timer 42) is measured. The controller 13 determines whether this elapsed time t exceeds a predetermined time tt (Step 5).

At this time, when the time t is shorter than the predetermined time tt, the writing completion response is output to the host device 201 after the writing of data is completed.

By contrast, when the time t is longer than the predetermined time tt, the writing completion response is output to the host device 201 after a predetermined time (for example, 30 seconds) transpires (Step 6) after the writing of the write data is completed.

In general, the temperature of the controller 13 of the semiconductor device 1 increases with an increase in the processing time (i.e., the time taken for writing data on the NAND memory 12 in the case of the present exemplary embodiment) of the semiconductor device 1.

In the present exemplary embodiment, when the predetermined time tt is set as a threshold value and the time t measured for the actual writing process is longer than the predetermined time tt, a time interval that allows the surface temperature of the semiconductor device 1 to decrease is implemented by standing by for a predetermined time interval (a standby time) before the writing completion response is output to the host device 201. Therefore, even when the user removes the semiconductor device 1 immediately after the user receives the writing completion notification, the user is prevented from receiving a burn; the semiconductor device 1 is in a state in which the surface temperature of the semiconductor device 1 has cooled to below a dangerous temperature (for example, 70° C. or lower).

Thus, in the present exemplary embodiment, the temperature of the controller 13 may be determined if the time t necessary for data processing is known, even without the temperature monitoring function of the thermal sensor 37 described in the first exemplary embodiment. As illustrated in FIG. 13, the total amount of processed data may be determined when the time t between the start and completion of writing data is measured by the timer 42, assuming that the processing capacity of the controller 13 is substantially constant.

For this reason, if (1) the data processing amount (processing capacity) per unit time of the controller 13, (2) the rate of temperature increase per unit time during processing of data, and (3) the rate of temperature decrease per unit time when data are not being processed are all known, the temperature of the controller 13 may be determined from the time t measured for processing data, even without the temperature monitoring function of the thermal sensor 37 described in the first exemplary embodiment. Furthermore, based on knowledge of (1), (2), and (3), the predetermined time tt can be similarly determined, where the predetermined time tt is a threshold value for time t at which the controller 13 reaches an excessively high temperature, such as a temperature greater than the predetermined maximum removal temperature Tb.

Further, in the present exemplary embodiment, the function of the timer 42 is not limited to measurement of the time t taken from the start to completion of data processing. For example, the timer 42 may measure a time t2 taken from a time when the semiconductor device 1 is electrically connected to the host device 201 to a time when the data processing is completed.

In addition, in the present embodiment, the timer 42 may be configured as described above or the operation time may be measured using a clock function of an analog portion (not illustrated) provided in the controller 13.

Further, in the present exemplary embodiment, the thermal sensor 37 may also be provided in the controller 13 in the same manner as that of the first exemplary embodiment. In such an embodiment, the thermal sensor 37 monitors the temperature of the controller 13, and the writing completion information may be output to the host device 201 after the temperature T of the controller 13 at the time of completion of writing data is decreased to a predetermined maximum removal temperature Tb (for example, Tb is 70° C.)

Moreover, the thermal sensor 37 is not necessarily provided in the controller 13 even in the present exemplary embodiment. In the same manner as that of the first and second exemplary embodiments, the thermal sensor 37 may be disposed on the substrate 11 separately from the controller 13. Further, the timer 42 may be disposed on the substrate 11 separately from the controller 13.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
an interface to a host device;
a semiconductor memory element; and
a controller configured to perform a write operation on the semiconductor memory element in response to a command received from the host device, and upon completion of the write operation, either output a completion notification to the host device or suspend outputting the completion notification based on a load on the controller.

2. The memory device according to claim 1, wherein the load is indicated by a temperature of the controller.

3. The memory device according to claim 1, wherein the controller is configured to perform another write operation in response to another write command received from the host device while the completion notification has been suspended.

4. The memory device according to claim 1, wherein the controller outputs the completion notification to the host device upon completion of the write operation, if the temperature of the controller is less than a threshold value.

5. The memory device according to claim 4, wherein, upon completion of the write operation, if the temperature of the controller is greater than the threshold value, the controller outputs the completion notification to the host device after suspending the outputting of the completion notification to the host device for a predetermined amount of time.

6. The memory device according to claim 4, wherein, upon completion of the write operation, if the temperature of the controller is greater than the threshold value, the controller suspends the outputting of the completion notification to the host device until the temperature of the controller becomes less than the threshold value.

7. The memory device according to claim 1, further comprising a temperature sensor configured to measure the temperature of the controller.

8. The memory device according to claim 7, wherein the controller is configured to compare the temperature of the controller with a threshold temperature of the controller to determine whether to output a completion notification to the host device or suspend outputting the completion notification.

9. The memory device according to claim 8, wherein the threshold temperature of the controller is less than a maximum operating temperature of the memory device.

10. The memory device according to claim 8, wherein the threshold temperature of the controller corresponds to a temperature at which the memory device can be safely removed from the host device.

11. The memory device according to claim 1, further comprising a substrate that has a first surface on which the interface, the semiconductor memory element, and the controller are disposed.

12. The memory device according to claim 11, wherein, on the first surface, the controller is between the interface and the semiconductor memory element.

13. A memory device comprising:
an interface to a host device;
a semiconductor memory element; and
a controller configured to perform a write operation on the semiconductor memory element in response to a command received from the host device, and upon completion of the write operation, either output a completion notification to the host device or suspend outputting the completion notification based on a total amount of data written in response to the command.

14. The memory device according to claim 13, wherein the controller is configured to perform another write operation in response to another write command received from the host device while the completion notification has been suspended.

15. The memory device according to claim 13, wherein the controller outputs the completion notification to the host device upon completion of the write operation, if the total amount of data written in response to the command is less than a threshold value.

16. The memory device according to claim 15, wherein, upon completion of the write operation, if the total amount of data written in response to the command is greater than the threshold value, the controller outputs the completion notification to the host device after suspending the outputting of the completion notification to the host device for a predetermined amount of time.

17. The memory device according to claim 13, wherein the controller is configured to compare the total amount of data written in response to the command with a threshold value to determine whether to output a completion notification to the host device or suspend outputting the completion notification.

18. A memory device comprising:
an interface to a host device;
a semiconductor memory element; and
a controller configured to perform a write operation on the semiconductor memory element in response to a command received from the host device, and upon completion of the write operation, either output a completion notification to the host device or suspend outputting the completion notification based on a total amount of time taken to perform the write operation.

19. The memory device according to claim 18, wherein the controller outputs the completion notification to the host device upon completion of the write operation, if the total amount of time taken to perform the write operation is less than a threshold value.

20. The memory device according to claim 19, wherein, upon completion of the write operation, if the total amount of time taken to perform the write operation is greater than the threshold value, the controller outputs the completion notification to the host device after suspending the outputting of the completion notification to the host device for a predetermined amount of time.
